(19) United States
(12) Patent Application Publication
(10) Pub. No.: US 2023/0366666 A1
(43) Pub. Date: Nov. 16, 2023

(54) Adhesive Measuring Tape

(71) Applicant: Meredith Hall, Weslaco, TX (US)

(72) Inventor: Meredith Hall, Weslaco, TX (US)

(21) Appl. No.: 18/147,014

(22) Filed: Dec. 28, 2022

Related U.S. Application Data
(60) Provisional application No. 63/340,042, filed on May 10, 2022.

(51) Int. Cl. G01B 3/1084

(52) U.S. Cl. CPC G01B 3/1084; G01B 2003/1097

(57) ABSTRACT

The present invention relates generally to the field of measuring tool. More specifically, the present invention relates to an adhesive measuring tape that has a bottom surface and a top surface. The bottom surface has an adhesive coating, while the top surface has a plurality of indicia such as at least one of a metric measurement, an imperial measurement, and a customizable measurement. In one embodiment, the invention includes a dispenser having an interior space, with at least one spool, at least one spring, at least one button, and at least one opening. The dispenser has at least one tear bar and at least one hinge.

### CROSS-REFERENCE TO RELATED APPLICATION

The present application claims priority to, and the benefit of, U.S. Provisional Application No. 63/340,042, which was filed on May 10, 2022, and is incorporated herein by reference in its entirety.

### FIELD OF THE INVENTION

The present invention relates generally to the field of measuring tools. More specifically, the present invention relates to an adhesive measuring tape. The measuring tape has a bottom surface and a top surface. The bottom surface is provided with an adhesive coating, while the top surface has a plurality of indicia such as at least one set of metric measurement indicia, at least one imperial measurement indicia, and at least one customizable measurement or note area. In one embodiment, the measuring tape has a dispenser or housing that includes an interior space, at least one spool, at least one spring, at least one button, and at least one opening. The dispenser further includes at least one tear bar and at least one hinge. The measuring tape is advantageous as it provides users with the ability to take hands-free, precise measurements more efficiently. Accordingly, the present disclosure makes specific reference thereto. Nonetheless, it is to be appreciated that aspects of the present invention are also equally applicable to other like applications, devices, and methods of manufacture.

### BACKGROUND

Carpenters and laymen often must take measurements to ensure that their work or tasks are completed correctly. Being off even an eighth of an inch or a few millimeters when constructing something can prove to be catastrophic to the build. Ordinary tape measures can be frustrating to use when used by a single person due to the need to hold the tape measure as well as mark the distance for example to cut a piece of wood, tile, or other material. Further, existing tape measures have either imperial or metric measurements or markings and have no customizable options. Some carpenters use regular tape to mark surfaces to try and get around these issues, but regular tape can damage walls or other objects when it is removed.

Therefore, there exists a long-felt need in the art for an improved measuring device. Further, there exists a long-felt need in the art for an adhesive measuring device that eliminates the need for a user to hold a tape measure while also taking the needed measurements. There also exists a long-felt need in the art for an adhesive measuring tape device that sticks, or otherwise adheres to surfaces for hands-free use and more accurate measuring. There also exists a long-felt need in the art for an adhesive measuring tape that can easily be applied to objects and removed without damaging the surface the device was placed on.

The subject matter disclosed and claimed herein, in one embodiment thereof, comprises an adhesive measuring tape tool. In one embodiment, the device has a dispenser, which includes a housing, an interior space, at least one spool, a supply of material mounted on the spool, at least one spring, at least one tear bar, and a measuring tape. The dispenser allows for easy application of the measuring tape and ensures that the measuring tape remains intact.

The measuring tape has a top surface, with indicia such as metric, imperial, and customizable measurements. The measuring tape has a bottom surface with an adhesive coating that allows the tape to be stuck to a plurality of surfaces for convenient measuring. The top surface may have a light release coating to allow the supply of material, particular the adhesive, to easily unwind from the spool. The release coating may be writable to enable a user to apply additional markings to the top surface of the tape.

In this manner, the adhesive measuring tape device of the present invention accomplishes all of the foregoing objectives and provides a novel means of taking measurements. Further, the device allows a user to be able to apply an adhesive measuring tape to any surface and be able to take accurate hands-free measurements.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises an adhesive measuring tape tool or accessory. In one embodiment, the device may have a supply of material such as a pre-configured measuring tape wrapped around a center member or a core. The measuring tape has a top surface, a bottom surface, and indicia. The top surface may have a coating of release material, such as silicone, wax, or clay. The release coating ranges from an easy release to a medium level release depending on the type of adhesive that is used on the tool.

The measuring tape has a top surface, and a bottom surface which includes an adhesive coating which may be applied as full coated adhesive pattern, a spot applied pattern, or other pattern. In the preferred embodiment, the bottom surface has an adhesive coating which allows a user to place the measuring tape onto a surface. The adhesive may also be an activable adhesive which can be triggered when needed. In the preferred embodiment, the top surface of the measuring tape is not provided with an adhesive coating but may be provided with a release coating. This non-stick top surface allows the user to easily write on the measuring tape as well as easily remove the measuring tape when the user is finished. The measuring tape may be provided with at least one separation line which may be perforation lines or tear lines. This provides the user with a way to tear portions of the measuring tape for use with minimal effort.

The measuring tape has indicia provided on at least the top surface. Indicia may also be provided on the bottom surface, such as the name of the manufacturer, reorder information, disposal instructions or other useful information. In the preferred embodiment, the indicia used are at least one imperial measurement, at least one metric measurement or combinations thereof, and at least one customizable measurement or note area. The measuring tool, in one embodiment, includes both imperial measurements and metric measurements to provide a user with the ability to use either measurement without switching between tools or other accessories. Further, the device has customizable measurements or a note area, in that the user may write in their own measurements to track the needed measurements more accurately for the specific job.

In one embodiment, the bottom surface of the measuring tape has a peelable member or a release liner. In this embodiment, the bottom surface of the measuring tape does not have the adhesive coating exposed until the peelable member or release liner is removed from the bottom surface. This prevents the measuring tape from becoming inadvertently stuck on surfaces that the user does not intend to stick the measuring tape to.

In one embodiment, the device may have a dispenser. The dispenser has a housing, which includes an interior space that holds the supply of measuring tape. The housing further includes at least one opening located at a terminus point of the housing. The opening allows a user to pull the measuring tape through the housing and out onto the desired area for measuring. The opening may include a tear bar so as to be able to tear off and remove the measuring tape for use.

The housing also has at least one lid. The lid can be maneuvered to access the opening. The lid is opened and closed via at least one hinge. The housing also has an interior space suitable in size to hold a supply of measuring tape. The interior space has at least one spool. The spool may be any shape or orientation known in the art that allows for the user to easily extend and retract the measuring tape. The spool may have at least one spring. The spring makes the spool spring loaded; in that it retracts with minimal effort.

The housing may have at least one button. In one embodiment, the button may be in the form of a pressable or depressible button that when pressed, measuring tape is able to advance or retract. In this embodiment, when the user pushes the button one time, it allows for the user to pull the measuring tape out to the desired in length. When the user presses the button a second time, it locks the measuring tape at the desired length. When the user presses the button a third time, it retracts the measuring tape all the way into the housing.

In another embodiment, there may be multiple buttons, where one button allows the measuring tape to be pulled to the desired length, another button locks the measuring tape, and another button automatically retracts the measuring tape back into the housing. In another embodiment, the button may be in the form of a switch, wherein at different orientations, the switch functions to extend, retract, or lock the measuring tape.

In varying embodiments, the housing may also have a locking mechanism. The locking mechanism allows the user to lock the measuring tape in place at the desired length. The locking mechanism is activated and operated via the button. Accordingly, the adhesive measuring tape device of the present invention is particularly advantageous as it provides users with a way to take hands-free measurements with minimal effort. In this manner, the adhesive measuring tape device overcomes the limitations of existing measuring devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an adhesive measuring tape of the present invention in accordance with the disclosed architecture;

FIG. 2A illustrates an enhanced perspective view of one potential embodiment of an adhesive measuring tape of the present invention in accordance with the disclosed architecture;

FIG. 2B illustrates a perspective view of one potential liner-less embodiment of an adhesive measuring tape of the present invention in accordance with the disclosed architecture;

FIG. 3 illustrates a perspective view of one potential embodiment of an adhesive measuring tape of the present invention attached to a wall in accordance with the disclosed architecture;

FIG. 4 illustrates a perspective view of one potential embodiment of an adhesive measuring tape of the present invention with the peelable adhesive member or release liner in accordance with the disclosed architecture; and

FIG. 5 illustrates an exploded side view of one potential embodiment of an adhesive measuring tape in a dispenser of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved measuring device. Further, there exists a long-felt need in the art for an adhesive measuring tool that eliminates the need for a user to hold a tape measure while taking measurements. There also exists a long-felt need in the art for an adhesive measuring tape that sticks to surfaces to allow for hands-free use and more accurate measuring of the surface. There also exists a long-felt need in the art for an adhesive measuring tape tool that can easily be applied to objects and removed without damaging the surface the tape was placed on.

The present invention, in one exemplary embodiment, is comprised of an adhesive measuring tape tool. The measuring tape further includes a supply of measuring tape material, at least one set of measurement indicia which may be imperial, metric, or combinations thereof, and at least one area to provide for a customizable measurement or to add customized or personalized notations. The measuring tape further includes a bottom surface that has an adhesive coating. The adhesive may be active, inactive, or activatable and may be provided on the entire surface area of the tape or in a predefined pattern, such as spots or lines along the length of the tape. In one embodiment, the device includes a housing, with at least one interior space, at least one button, at least one locking mechanism, and at least one tear bar. Within the interior space is at least one spool, a core on the spool, a supply of material, and at least one spring. The spool and spring allow for the material to be automatically retracted when the user presses the button, and the supply of material is provided on the core which allows for mounting on the spool.

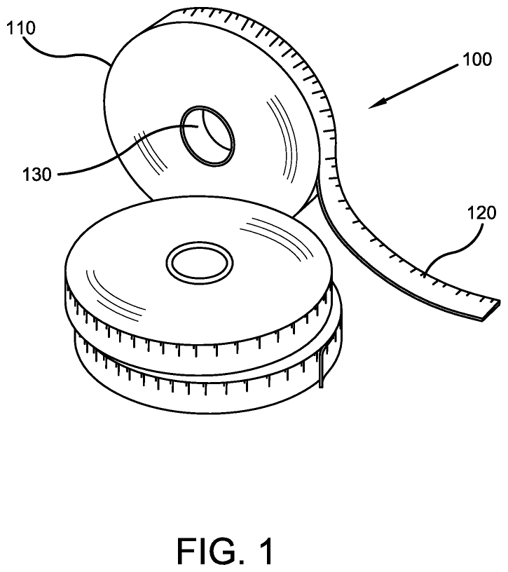

Referring initially to the drawings, FIG. 1 illustrates a perspective view of one potential embodiment of an adhesive measuring tape tool 100 of the present invention in accordance with the disclosed specification. The tool 100 has a body or housing 110, which holds a measuring tape 120, and the tape is wound on a core or center member 130.

In one embodiment, the device 100 is a measuring tape 120 wrapped around a core or center member 130. The center member or core 130 may be any size or shape known in the art but is preferably cylindrical. The center member or core 130 may further be manufactured from any material known in the art such as, but not limited to, plastic, cardboard, paper, wood, metal, etc. The measuring tape 120 can be any strip material known in the art such as, but not limited to: plastic, paper, laminate, cardstock, or combinations thereof. The material forming the substrate for the measuring tape 120 may be made from virgin material or produced from post-consumer waste or renewable materials.

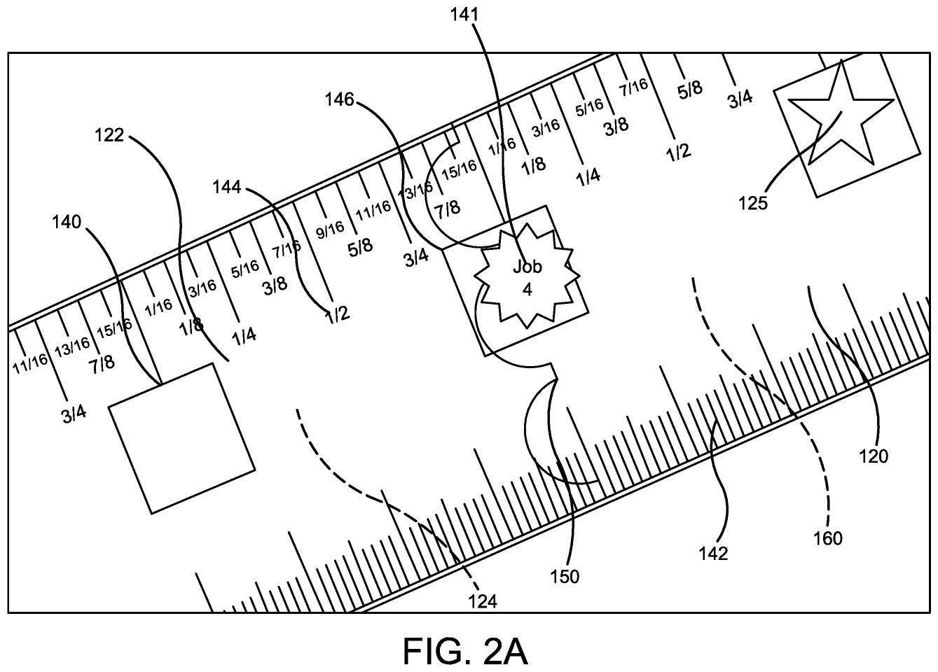

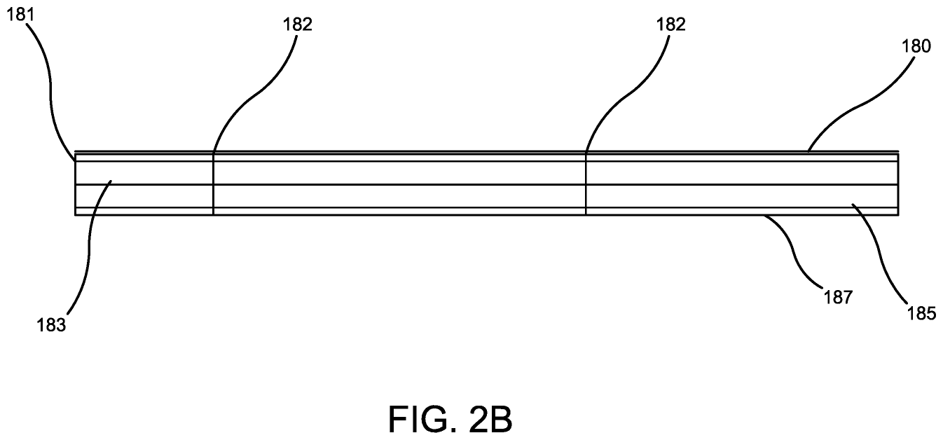

FIG. 2A illustrates an enhanced perspective view of one potential embodiment of an adhesive measuring tape tool 100 of the present invention in accordance with the disclosed specification. The measuring tape 120 has a top surface 122, a bottom surface 124, and indicia 140.

The measuring tape 120 has a top surface 122, and a bottom surface 124 and the bottom surface has an adhesive coating 160. In the preferred embodiment, the bottom surface 124 has an adhesive coating 160 which allows a user to adhere the measuring tape 120 onto a surface. The adhesive may be one of a removable, repositionable, or permanent adhesive. The adhesive coating 160 is preferably an acrylic adhesive but may be any adhesive known in the art that will not damage the desired surface. In the preferred embodiment, the top surface 122 of the measuring tape 120 is not provided with adhesive coating 160 but may have a release coating such as silicone, clay or wax deposited onto the surface so that the adhesive coating, if provided in a “liner-less” configuration, does not stick to the top surface while the tape is wound onto a roll. This non-stick top surface 124 allows the user to easily write on the measuring tape 120 as well as easily remove the measuring tape 120 when the user is finished. The measuring tape 120 may be provided with at least one separation line 150 which may be perforation lines or tear lines. The perforation line should include a series of cuts and ties, with the cuts ranging from about 0.8 mm to about 12 mm and the tie size (the portion of the substrate remaining in between each of the cuts) ranging from about 0.5 mm to about 2 mm.

The measuring tape 120 includes indicia 140. In the preferred embodiment, the indicia 140 used are at least one of a first measurement, such as an imperial measurement 144; a second measurement, such as a metric measurement 142; a third measurement or customizable measurement, note, personalization area, 146 or some combination of the three types of measurements. In one embodiment, the tape may have a first measurement and a third measurement. In another embodiment, the tape may have a second measurement and a third measurement, or a first and a second measurement. Various other combinations are of course possible. The tape 100, in one embodiment, has both imperial 144 and metric measurements 142 to provide a user with the ability to use either measurement without switching between different tools or devices having the specific measurement type that is desired. Further, the tape 100 has a customizable measurement, note, or personalization area 146, in that the user may write in their own measurements to track the needed measurements more accurately for the specific job, add a note, such as the presence of a nail or knot in the wood or other notes, which may relate to the job or order being prepared 141. The customization area 146 may include additional graphics 125 or other indicia that the user may add.

FIG. 2B illustrates a perspective view of one potential liner-less embodiment of an adhesive measuring tape of the present invention in accordance with the disclosed architecture, in which the substrate 183 has a top surface 181 that is provided with a release coating 180, such as silicone, clay or wax. The bottom surface 185 is provided with an active adhesive coating 187. When the tape is wound onto itself, the exposed adhesive 187 of the bottom surface will not adhere to the top surface 181 of the tape layer due to the release coating 180 provided on the top surface 181. The release coating 180 may have a thickness ranging from 0.1 mm to about 2 mm, with about 0.5 mm to 1 mm being preferred, for a light tack type of adhesive. Lines of perforation or tear lines 182, are shown extending through the top surface, bottom surface, and substrate as well as any coating that may be applied on the surfaces. It should be understood that if a release liner or separation liner is provided to keep the surfaces from adhering together, the line of perforation or tear lines would extend through the liner as well. The tear lines or perforation lines are provided at regularly occurring intervals, such as every inch, every three inches, every twelve inches or any other combination that may be desired.

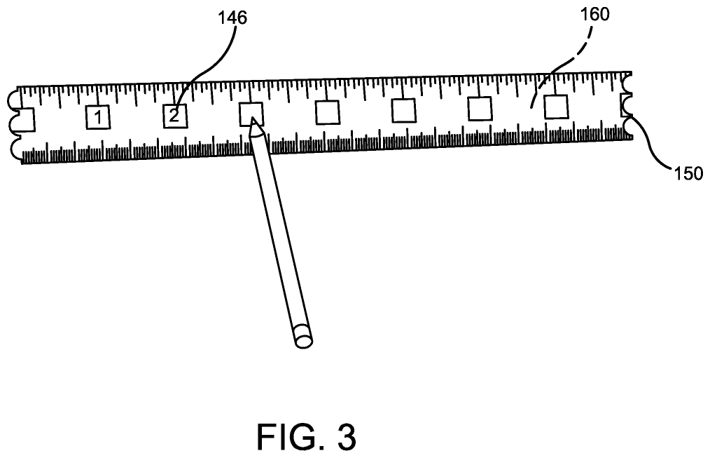

FIG. 3 illustrates a perspective view of one potential embodiment of an adhesive measuring tape tool 100 of the present invention attached to a wall in accordance with the disclosed specification. The tool 100 is attached to the desired surface via the adhesive coating 160 located on the back surface 124 of the measuring tape 120. The measuring tape 120 may be torn at the separation tabs or lines 150 and attached to the wall for measurement. The perforation line should include a series of cuts and ties, with the cuts ranging from about 0.8 mm to about 12 mm, and the tie size (the portion of the substrate remaining in between each of the cuts) ranging from about 0.5 mm to about 2 mm. Further, the user may write customized measurements 146 on the measuring tape 120.

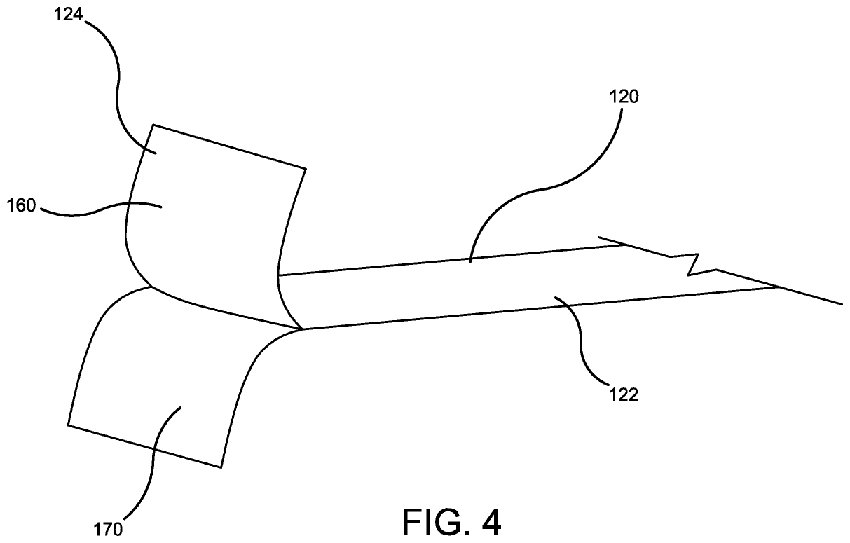

FIG. 4 illustrates a perspective view of one potential embodiment of an adhesive measuring tape tool of the present invention with a peelable adhesive member or release liner in accordance with the disclosed specification. In one embodiment, the bottom surface 124 of the measuring tape 120 has a peelable member 170 releasably attached to the adhesive. In this embodiment, the bottom surface 124 of the measuring tape 120 does not have the adhesive coating 160 exposed until the peelable member or release liner 170 is removed from the bottom surface 124. This prevents the measuring tape 120 from becoming inadvertently stuck on surfaces that the user does not intend to stick the measuring tape 120 to. Once a user peels back the peelable member or release liner 170, the adhesive coating 160 is then exposed and the measuring tape 120 is ready to be adhered to the desired surface.

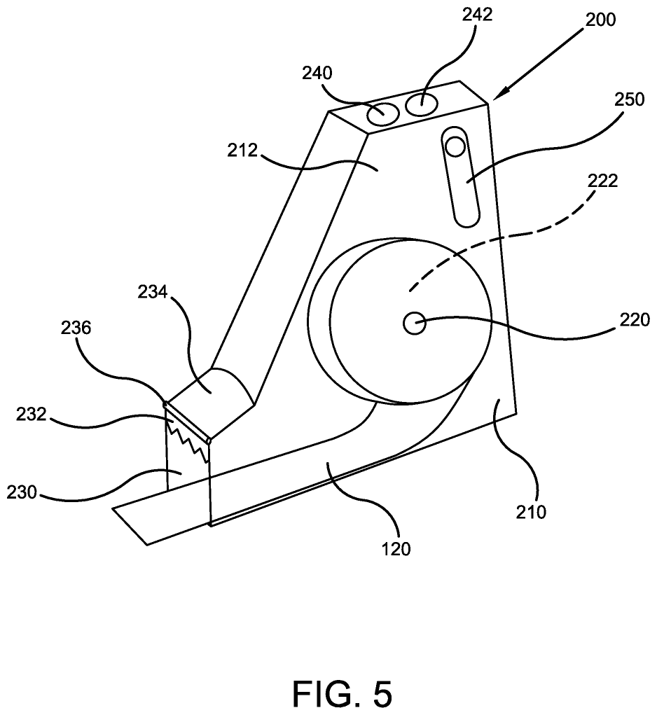

FIG. 5 illustrates an exploded side view of one potential embodiment of an adhesive measuring tape 100 in a dispenser 200 of the present invention in accordance with the disclosed specification. In one embodiment, the tool 100 may include a dispenser 200. The dispenser 200 has a housing 210 with an interior space 212 that holds the supply of measuring tape 120. In various embodiments, the housing 210 and all components may be made from a plurality of materials. One such material is a metal such as, but not limited to, brass, copper, aluminum, stainless steel, and combinations thereof. The preferred material is a rigid plastic such as, but not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, recycled plastic, biodegradable plastic, and combinations thereof. In one embodiment, the housing may have at least one clip 250. The clip 250 allows the dispenser and the device 100 to be attached to a user's pants or tool belt for easy and convenient access. The clip 250 may further be any clip known in the art.

In differing embodiments, the housing 210 may be any shape such as, but not limited to: square, circle, polygonal, etc. In addition, the housing 210 may be shaped as any indicia such as, but not limited to: patterns, logos, emblems, images, symbols, designs, letters, numbers, words, characters, insects, advertisements, brands, or combinations thereof, to give the housing 210 a themed appearance.

The housing 210 further includes at least one opening 230 located in the housing 210. The opening 230 allows a user to pull the measuring tape 120 through the housing 110 and out onto the desired area. The opening 230 may include a tear bar 232 so as to be able to tear off and remove the measuring tape 120 for use.

The housing 210 also has at least one lid 234. The lid 234 can be maneuvered to access the opening 230 and interior space 212. The lid 232 is opened and closed via at least one hinge 236. In various embodiments, the hinge 236 may be any hinge type known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

The housing 210 has an interior space 212 suitable in size to hold a supply of measuring tape 120. The interior space 212 has at least one spool 220. The spool 220 may be any shape or orientation known in the art that allows for the user to easily extend and retract the measuring tape 120. The spool 220 may have at least one spring 222. The spring 222 makes the spool 220 spring loaded, in that it retracts with minimal effort. The spring 222 may be any spring or manufactured from any spring material known in the art.

The housing 210 may have at least one button 240. In one embodiment, the button 240 may be in the form of a pressable or depressible button 240 that when pressed, measuring tape 120 either is able to extend or retract. In this embodiment, when the user pushes the button 240 one time, it allows for the user to pull the measuring tape 120 out to the desired in length. When the user presses the button 240 a second time, it locks the measuring tape 120 at the desired length. When the user presses the button 240 a third time, it retracts the measuring tape all the way into the housing 210.

In another embodiment, there may be multiple buttons 240, wherein one button 240 allows the measuring tape 120 to be pulled to the desired length, another button 240 locks the measuring tape 120, and another button 240 automatically retracts the measuring tape 120 back into the housing 210. In another embodiment, the button 240 may be in the form of a switch, wherein at different orientations, the switch functions to extend, retract, or lock the measuring tape.

In varying embodiments, the housing 210 may also have a locking mechanism 242. The locking mechanism 242 allows the user to lock the measuring tape 120 in place at the desired length. The locking mechanism 242 is activated and operated via the button 240. The locking mechanism 240 can be any locking mechanism known in the art such as, but not limited to: a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a mechanical dial lock, a numerical combination lock, a pedestal lock, a draw lock, a fixed core lock, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adhesive measuring tape”, “tool” and “device” are interchangeable and refer to the adhesive measuring tape tool 100 of the present invention.

Notwithstanding the foregoing, the adhesive measuring tape 100 of the present invention and its various components can be of any suitable size and configuration as is known in the art without affecting the overall concept of the invention, provided that they accomplish the above-stated objectives. One of ordinary skill in the art will appreciate that the size, configuration, and material of the adhesive measuring tape 100 as shown in the FIGS. Are for illustrative purposes only, and that many other sizes and shapes of the adhesive measuring tape 100 are well within the scope of the present disclosure. Although the dimensions of the adhesive measuring tape 100 are important design parameters for user convenience, the adhesive measuring tape 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A measuring tool comprising:
a measuring tape comprised of a substrate having a top surface and a bottom surface;
an adhesive provided on the bottom surface;
a measurement indicia provided on the top surface; and
a plurality of tear lines extending through the substrate and the adhesive, wherein the plurality of tear lines occur at regular intervals along the measuring tape.

2. The measuring tool as recited in claim 1, wherein the plurality of tear lines are comprised of an alternating series of cuts and ties.

3. The measuring tool as recited in claim 2, wherein the cuts range from about 0.8 mm to about 12 mm, and the ties range from about 0.5 mm to about 2 mm.

4. The measuring tool as recited in claim 1, wherein the adhesive is one of a repositionable adhesive, a removable adhesive or a permanent adhesive.

5. The measuring tool as recited in claim 1, wherein the measurement indica comprises at least one of a first measurement indicia, a second measurement indicia and a third measurement indicia.

6. The measuring tool as recited in claim 1, wherein the first measurement indica is an imperial measurement indica, the second measurement indicia is a metric measurement indicia and the third measurement indicia is a customizable measurement indicia.

7. The measuring tool as recited in claim 5, wherein the measuring tape comprises each of the first measurement indicia, the second measurement indicia and the third measurement indicia.

8. The measuring tool as recited in claim 6, wherein the customizable measurement indicia comprises a personalization information and a graphic.

9. The measuring tool as recited in claim 1, wherein the adhesive is provided in a pattern, a spot coating or a full coating on the bottom surface of the substrate.

10. The measuring tool as recited in claim 1, wherein the measuring tape is provided on a cardboard core.

11. A measuring tape comprising:
a housing comprising an interior space, an opening and a lid;
a tear bar provided on the opening;
a supply of measuring tape supplied on a core, wherein the measuring tape is comprised of a substrate having a top surface and a bottom surface and an adhesive provided on the bottom surface, and further wherein the adhesive is one of a removable adhesive, a repositionable adhesive or a permanent adhesive; and
a combination of measurement indicia provided on the top surface of the substrate.

12. The measuring tape as recited in claim 11, wherein the combination of measurement indicia comprises an imperial indicia, a metric indicia or a customizable indicia.

13. The measuring tape as recited in claim 11 further comprising a plurality of tear lines provided at regular intervals along a length of the measuring tape.

14. The measuring tape as recited in claim 11, wherein the adhesive is provided in a pattern, a spot coating or a full coating on the bottom surface of the substrate.

15. The measuring tape as recited in claim 13, wherein the plurality of tear lines are comprised of a series of cuts and ties, and further wherein and the cuts range from about 0.8 mm to about 12 mm and the ties range from about 0.5 mm to about 2 mm.

16. The measuring tape as recited in claim 11, wherein the housing further comprises a spring and a button to advance or retract the measuring tape.

17. The measuring tape as recited in claim 12, wherein the customizable measurement indica comprises notes and graphics.

18. The measuring tape as recited in claim 11, wherein the housing further comprises a locking mechanism.

19. An adhesive measuring tape comprising:
a substrate comprised of a top surface and a bottom surface, wherein the top surface comprises at least one of a metric indicia, an imperial indicia or a customizable measurement indica, and further wherein the substrate is wound onto a core;
an adhesive provided on the bottom surface;
a release material provided on one of the top surface or the bottom surface; and
a plurality of lines of perforation spaced at regular intervals along a length of the substrate, wherein the plurality of lines of perforation are comprises of a series of cuts and ties, and further wherein the cuts range from about 0.8 mm to about 12 mm and the ties range from about 0.5 mm to about 2 mm.

20. The adhesive measuring tape as recited in claim 19, wherein the top surface comprises each of the metric indicia, the imperial indicia and the customizable measurement indica.
